(19) United States
(12) Patent Application Publication
(10) Pub. No.: US 2010/0027247 A1
(43) Pub. Date: Feb. 4, 2010

(54) PORTABLE OUTDOOR FIXTURE FOR LEISURE AREA

(75) Inventor: Michael E. Olsen, Frisco, TX (US)

Correspondence Address: MUNSCH, HARDT, KOPF & HARR, P.C.;INTELLECTUAL PROPERTY DOCKET CLERK, 3800 LINCOLN PLAZA, 500N AKARD STREET, DALLAS, TX, 75201, US

(73) Assignee: CRAFTMADE INTERNATIONAL INC., Coppell, TX (US)

(21) Appl. No.: 12/184,633

(22) Filed: Aug. 1, 2008

(51) Int. Cl. F21L 4/00

(52) U.S. Cl. 362/183

(57) ABSTRACT

A portable outdoor fixture adapted to be supported by a beam of a shelter structure including a mounting assembly, an extension arm, and an appliance. The mounting assembly has an adjustment member operably coupled to a fixed base to permit clamping of the beam. The adjustment member is releaseably locked in position relative to the fixed base through interaction of a ratchet mechanism interposed between the adjustment member and the fixed base. The extension arm extends from the fixed base of the mounting assembly toward a coupling end. The appliance is disposed at the coupling end of the extension arm.

### BACKGROUND

In both residential and commercial settings, a shelter structure having a partially or fully open roof with exposed support beams (e.g., a pergola, arbor, archway, etc.) may be employed to protectively cover or aesthetically enhance a leisure area (e.g., a patio, deck, porch, walkway, garden path, etc.) where people tend to congregate or pass through.

In some circumstances, either one or both the leisure area and the shelter structure are equipped with exterior lighting. This exterior lighting, which is often securely fixed in place, illuminates the leisure area to, for example, permit use of the leisure area into the twilight and evening hours, increase the safety and security surrounding the leisure area, or augment the aesthetic nature of the leisure area.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an embodiment of a portable outdoor fixture;

FIG. 2 is a perspective view of a fixed base included within the portable outdoor fixture of FIG. 1;

FIG. 3 is a perspective view of an adjustment member received within the fixed base of FIG. 2 to form a mounting assembly included from the portable outdoor fixture of FIG. 1;

FIG. 4 is a front elevation view of the mounting assembly of FIG. 3;

FIG. 5 is a is a cross-section of the mounting assembly taken through a ratchet mechanism from the mounting assembly of FIG. 4;

FIG. 6 is a side elevation view of the portable outdoor fixture of FIG. 1 in an unclamped state; and

FIG. 7 is a side elevation view of the portable outdoor fixture of FIG. 1 in a clamped state.

### DETAILED DESCRIPTION OF THE DRAWINGS

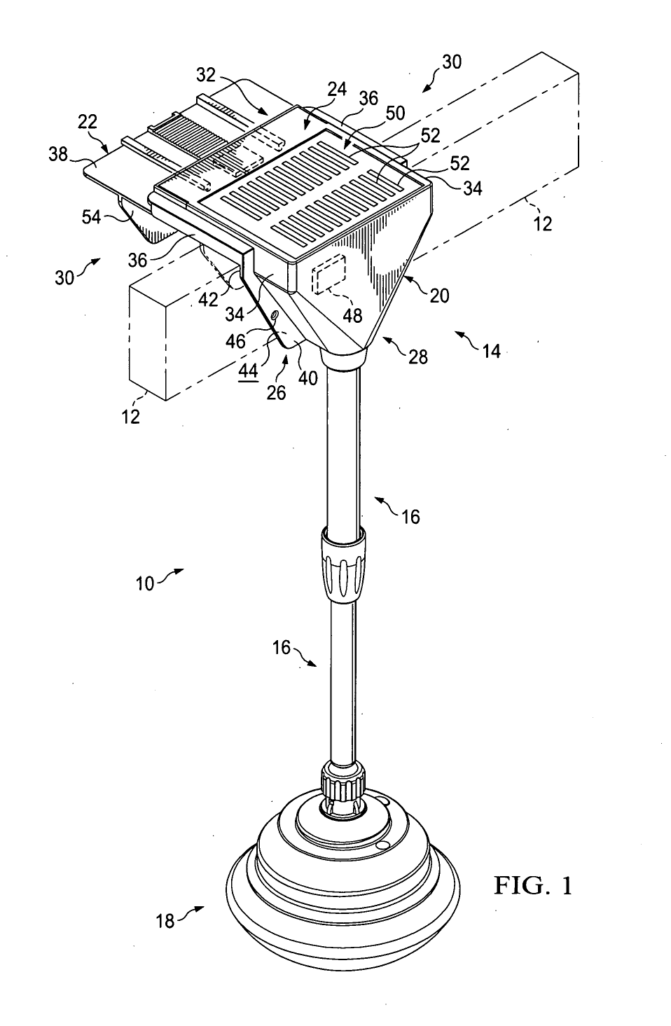

Referring to FIG. 1, a portable outdoor fixture 10 is illustrated. As will be more fully explained below, fixture 10 is adapted to be supported by an exposed support beam 12 of a shelter structure (e.g., a pergola, arbor, archway, etc.) employed to protectively cover or aesthetically enhance a leisure area (e.g., a patio, deck, porch, walkway, garden path, etc.) where people tend to congregate or pass through. When supported by the beam 12 in this manner, fixture 10 is able to, for example, provide lighting or some other benefit to the leisure area. In the illustrated embodiment of FIG. 1, fixture 10 includes a mounting assembly 14, an extension arm 16, and an appliance 18.

Mounting assembly 14 is generally divided into a fixed base 20 and an adjustment member 22. In the illustrated embodiment of FIG. 1, fixed base 20 has a top platform 24 and a depending abutment wall 26. As shown, abutment wall 26 is joined with and intersects top platform 24 proximate a back end 28 of fixed base 20. In this configuration, abutment wall 26 is transverse with top platform 24. Therefore, in the illustrated embodiment of FIG. 1 fixed base 20 generally has the overall shape of an “L” tipped on its side when the fixed base 20 is viewed from either side 30.

Beginning at or near front end 32 of fixed base 20 and running toward back end 28 thereof, side walls 34 of top platform 24 include a skirt 36. In the illustrated embodiment of FIG. 1, skirt 36 projects first outwardly and then downwardly from side walls 34. Due to this configuration, skirt 36 generally extends downwardly beyond a top plate 38 of adjustment member 22. Therefore, skirt 36 is able to hide a portion of top plate 38 when fixture 10 is viewed from either side 30.

Skirt 36 of top platform 24 terminates at, and merges with, an extension flange 40 of abutment wall 26. Extension flange 40 extends downwardly from skirt 36 toward appliance 18. Extension flange 40 forms a stop 42 that prevents adjustment member 22 from progressing further than desired into fixed base 20. Extension flange 40 is generally transverse with top platform 24 and collectively forms a planar abutment surface 44 along with an interior-facing portion of abutment wall 26.

In the illustrated embodiment of FIG. 1, extension flange 40 of abutment wall 26 includes one or more mounting apertures 46. Mounting apertures 46 are sized and dimensioned to receive a connection member (e.g., a nail, screw, bolt, etc.). Therefore, mounting apertures 46 may be employed to secure fixed base 20 to support beam 12, which may be formed from wood, steel, aluminum, or another suitable construction material. In some embodiments, mounting apertures 46 may be omitted from extension flange 40 or simply unused.

Still referring to FIG. 1, fixed base 20 generally supports both a rechargeable power source 48 (e.g., a battery) and a solar panel 50 formed from an array of solar cells 52 (a.k.a., photovoltaic cells). Even so, adjustment member 22 or some other component of mounting assembly 14 may support rechargeable power source 48 and/or solar panel 50 in other embodiments. Rechargeable power source 48 is in electrical communication with both solar panel 50 and appliance 18. Therefore, solar panel 50 is able to charge (or recharge) rechargeable power source 48 and rechargeable power source 48 is able to supply operative power to appliance 18. In some embodiments, rechargeable power source 48 is replaced by, or used in conjunction with, a replaceable power source (e.g., non-rechargeable battery, etc.) and/or a coupling providing electrical communication with an alternating current (AC) power source (e.g., available via an outlet).

As shown in FIG. 1, top plate 38 of adjustment member 22 supports a depending flange 54. Depending flange 54 and top plate 38 are generally transverse to each other. While depending flange 54 may be otherwise located in other embodiments, depending flange 54 is generally located near a middle portion of top plate 38 in the illustrated embodiment of FIG. 1. In some embodiments, dependent flange 54 is optional.

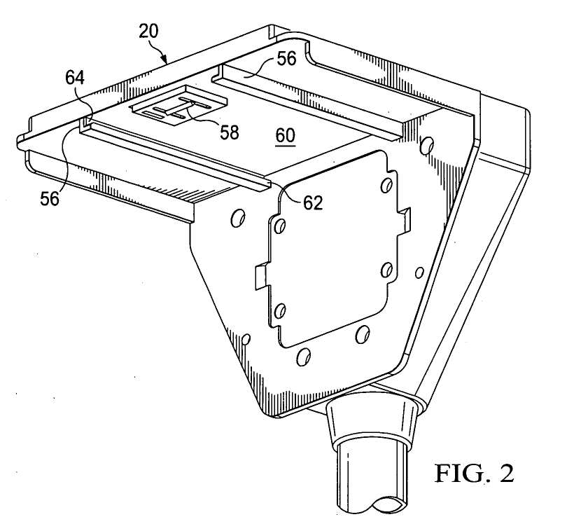

Referring now to FIG. 2, when adjustment member 22 is removed from fixture 10, fixed base 20 reveals a pair of spaced apart rail structures 56 and a resilient catch 58. Both rail structures 56 and resilient catch 58 depend from a bottom surface 60 of top platform 24 of adjustment member 22. In the illustrated embodiment of FIG. 2, each of rail structures 56 includes an inwardly-directed elongate shelf 62 spaced apart from bottom surface 60 by an offset wall 64.

As shown in FIG. 2, resilient catch 58 is interposed between rail structures 56. As will be more fully explained below, resilient catch 58 is configured to elastically deform when an interfering object is encountered and a sufficient amount of force is supplied to adjustment member 22. In the illustrated embodiment of FIG. 2, resilient catch 58 is a separate and distinct component secured to fixed base 20. Indeed, resilient catch 58 may be secured to fixed base 20 using, for example, rivets, epoxy, ultrasonic bonding, and the like. Even so, in other embodiments resilient catch 58 may be unitarily formed with fixed base 20.

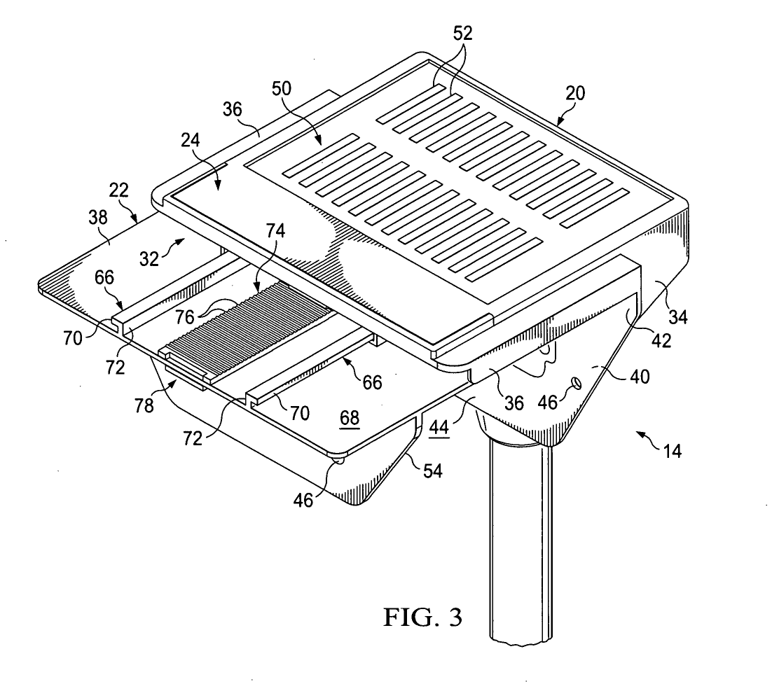

Moving now to FIG. 3, adjustment member 22 also includes a pair of spaced apart rail structures 66. However, rail structures 66 project upwardly from a top surface 68 of top plate 38. In the illustrated embodiment of FIG. 3, each of rail structures 66 includes an outwardly-directed elongate lip 70 spaced from top surface 68 by an offset wall 72.

As shown in FIG. 3, strip 74 is interposed between rail structures 66. Strip 74 includes a plurality of upwardly-projecting spaced-apart protuberances 76. In the illustrated embodiment of FIG. 3, strip 74 is in the form of a sawtooth with protuberances 76 formed by a plurality of individual teeth. Even so, in other embodiments strip 74 may be corrugated, serrated, stepped, ribbed, grooved or otherwise contoured to provide various types of protuberances 76. In the illustrated embodiment of FIG. 3, strip 74 is a separate and distinct component secured to adjustment member 22. Indeed, strip 74 may be secured to adjustment member 22 using, for example, rivets, epoxy, ultrasonic bonding, and the like. Even so, in other embodiments strip may be unitarily formed with adjustment member 22.

To facilitate application of a biasing force upon adjustment member 22, adjustment member 22 may be outfitted with a gripping structure 78. Gripping structure 78 is provided to permit and facilitate grabbing of, or gaining a handhold upon, adjustment member 22. In that regard, gripping structure 78 may be, for example, a pull strip, a knob, a loop of string, and the like.

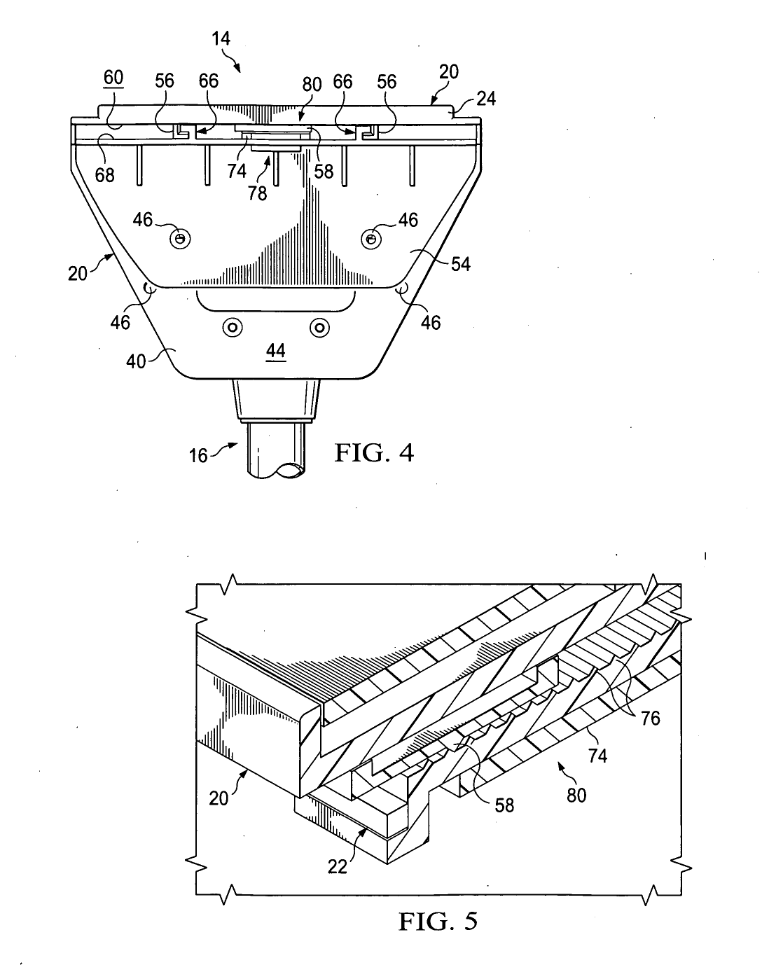

As shown in FIG. 4, when fixed base 20 and adjustment member 22 are operably coupled together, outwardly-directed lips 70 of rail structures 66 are seated upon inwardly-directed shelves 62 of rail structures 56. As such, when adjustment member 22 is moved relative to fixed base 20, lips 70 slide over shelves 62. In this configuration, adjustment member 22 is able to telescopically slide into and out of fixed base 20.

In addition, in the illustrated embodiment of FIG. 4 depending flange 54 of adjustment arm 22 includes one or more mounting apertures 46. Mounting apertures 46 are sized and dimensioned to receive a connection member. Therefore, mounting apertures 46 may be employed to secure adjustment arm 22 to support beam 12. In some embodiments mounting apertures 46 may be omitted from depending flange 54 or simply unused.

As shown in FIG. 5, resilient catch 58 and strip 74 are interposed between adjustment member 22 and fixed base 20 to form a ratchet mechanism 80. Ratchet mechanism 80 maintains adjustment member 22 releaseably locked in position relative to fixed base 20. Even though ratchet mechanism 80 is depicted as a resilient catch 58 engaging protuberances 76 on strip 74, ratchet mechanism 80 may have a variety of other configurations in other embodiments. Also, while resilient catch 58 is formed on fixed base 20 and strip 74 is formed on adjustment member 22 in FIG. 5, the location of these ratchet-forming components may be reversed.

As will be more fully explained below, when adjustment member 22 is moved relative to fixed base 20, resilient catch 58 engages one protuberance 76 of strip 74. When a sufficient amount of force is applied to adjustment member 22, resilient catch 58 and/or protuberance 76 of strip 74 elastically deform. This permits resilient catch 58 to move over protuberance 76 of strip 74. As this process continues, resilient catch 58 incrementally advances beyond each of the sequentially spaced-apart protuberances 76. In other words, strip 74 and resilient catch 58 permit positioning of adjustment member 22 relative to fixed base 20 in discrete increments. The size of the discrete increments depends upon, for example, the width between adjacent protuberances 76.

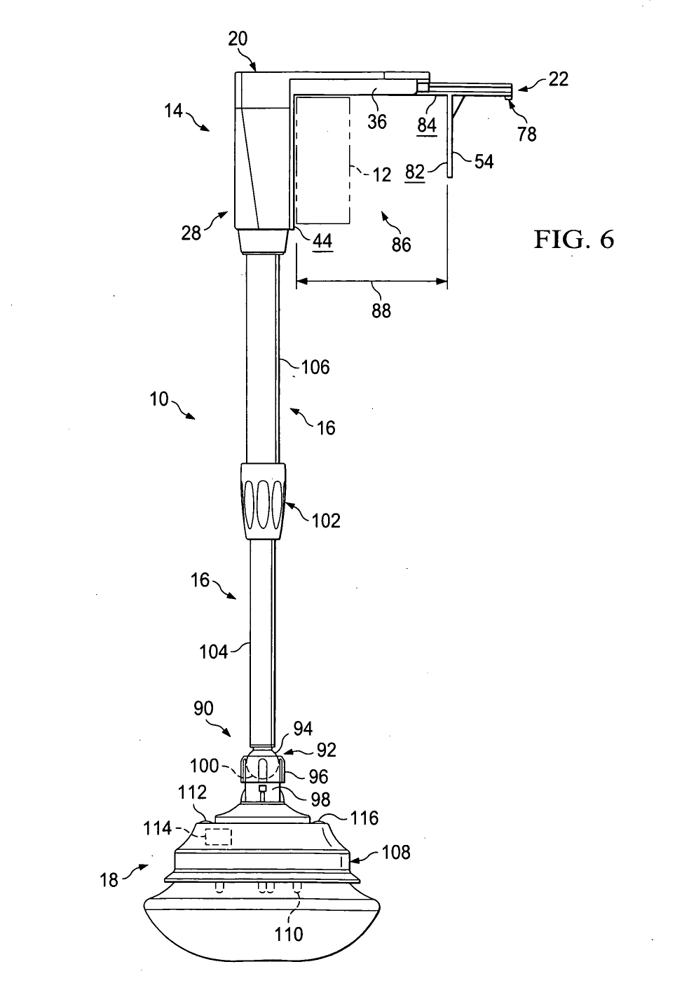

Moving now to FIG. 6, depending flange 54 of adjustment member 22 defines an abutment surface 82. Abutment surface 82 generally opposes abutment surface 44 of fixed base 20. Collectively, abutment surface 44, abutment surface 82, and a bottom surface 84 form a beam channel 86. In general, beam channel 86 is configured to receive the beam 12 of the support structure.

A width 88 of beam channel 86, measured between abutment surface 44 and abutment surface 82, is expanded or contracted by moving (e.g., horizontally sliding) adjustment member 22 away from or toward fixed base 20. As will be more fully explained below, when support beam 12 is disposed within beam channel 86, bottom surface 84 of adjustment member 22 engages with ands rest upon a top surface of support beam 12. In addition, width 88 of beam channel 86 is decreased until abutment surface 44 and abutment surface 82 collectively clamp opposing sides of support beam 12.

Still referring to FIG. 6, extension arm 16 extends from fixed base 20 of mounting assembly 14 toward a universal coupling end 90. Universal coupling end 90 is used to either permanently or temporarily attach the appliance to extension arm 16. In the illustrated embodiment of FIG. 6, universal coupling end 90 is a ball joint 92 configured to selectively receive one of a variety of different types of appliances. Ball joint 92 is also configured to permit electrical coupling of the chosen appliance to rechargeable power source 48. In some embodiments, universal coupling end 90 is an oscillating, rotating, and/or pivoting member that moveably couples the appliance and extension arm 16. In addition, in some embodiments, universal coupling end 90 is a rotating joint end or a multi-directional ball joint providing for linear and/or rotating motions or for bi-directional movement with three hundred sixty degree rotation.

In the illustrated embodiment of FIG. 6, ball joint 92 includes a ball 94 interposed between an internally-threaded sleeve 96 and an externally-threaded shaft 98. While the threads on sleeve 96 and shaft 98 are described as either internal or external, the threads may be otherwise disposed, interchanged, and the like.

When internally-threaded sleeve 96 is rotatably driven toward externally-threaded shaft 98, ball 94 is clamped in a socket 100 formed in the top of externally-threaded shaft 98. In contrast, when internally-threaded sleeve 96 is rotatably driven away from externally-threaded shaft 98, ball 94 is released from socket 100 formed in the top of externally-threaded shaft 98. Therefore, a different type of appliance 18 may be coupled to extension arm 16.

Despite ball 94 being clamped to secure appliance 18 to extension arm 16, ball 94 may still permit appliance 18 to swivel relative to extension arm 16 and/or fixed base 20. Therefore, appliance 18 may be moved by a user as desired. In addition, as shown in FIG. 6 extension arm 16 includes an adjustment mechanism 102 along a length thereof. Adjustment mechanism 102 is employed to increase or decrease the length of the extension arm to position appliance 18 further from, or closer to, fixed base 20. Adjustment mechanism 102 may also permit a lower section 104 of extension arm 16 to be completely detached from an upper section 106.

Appliance 18 is generally attached to universal coupling end 90 of extension arm 16. In the illustrated embodiment of FIG. 6, appliance 18 is a lamp 108 (a.k.a., a light). While lamp 108 may employ a variety of different light sources (e.g., an incandescent bulb, a fluorescent bulb, an electroluminescent element, etc.), lamp 108 includes a plurality of light emitting diodes (LED's) 110 that generate a form of electro-luminescence. Each of the LED's 110 may be of the same color or, in the alternative, one of a variety of different colors. In addition, each of the LED's 110 may change from one color to a different color or combine with other LED's 110 of various colors to produce light of a particular color. If desired, the LED's 110 may blink or otherwise cycle on and off to convey information. The LED's 110 may be directed downwardly away from fixed base 20, outwardly away from extension arm 16, or a combination thereof.

In addition to being a lamp 108 as shown in FIG. 6, appliance 18 may also be a ceiling fan, a combination light and a ceiling fan, a clock, a heater, a battery charger, stereo speakers, a sound system, an electric light for eliminating insects (a.k.a., a “bug zapper”), a scent-expelling or deodorizing device, a security device or alarm, a motion sensor, a rodent or animal deterrent device, a mirrored and/or lighted ball or other entertainment device, a cooling or spray mister, or another appliance that may be beneficial to a leisure area and/or a shelter structure. Indeed, using the universal coupling end 90, one of a variety of differently operating types of appliances may be quickly, easily and conveniently swapped for another. For example, lamp 108 may be replaced by a ceiling fan, the light may be removed in favor of a clock, a heater may be substituted for the light, a combination light and ceiling fan may be taken off so that the heater may be installed, and the like.

In the illustrated embodiment of FIG. 6, appliance 18 includes a multi-position switch 112. However, in other embodiments switch 112 may be located elsewhere in or on fixture 10. Switch 112 is able to transition appliance 18 between various states when manipulated. For example, when appliance 18 is lamp 108, switch 112 may be used to turn the LED's 110 on, turn the LED's 110 off, activate a timer or a sensor, or otherwise control operation of the lamp 108.

In addition to the above, a timer 114 may be incorporated into appliance 18. While shown on appliance 18, timer 114 may be found elsewhere in or on fixture 10. Timer 114 permits operation of lamp 108 for a predetermined or user selected time. Timer 114 may be electronic, mechanical, or a combination thereof.

As shown in the illustrated embodiment of FIG. 6, appliance 18 may also carry a sensor 116. While the shown on the appliance, sensor 116 may be found elsewhere in or on fixture 10. Sensor 116 operates to sense a characteristic, or lack of a characteristic, from the environment proximate appliance 18. When the characteristic or lack thereof is sensed or reaches a sufficient level, sensor 116 causes a change in the state of appliance 18. If, for example, sensor 116 is a motion detector, lamp 108 is turned on when motion is sensed and turned off when the motion has ceased for a period of time. In another example, if sensor 116 is a light-sensing sensor (e.g., a photodiode or a phototransistor) lamp 108 is turned off when light is sensed and turned on when an insufficient amount of light is sensed. Where appliance 18 is, for example, a heater, sensor 116 may be a thermostat monitoring the ambient temperature proximate appliance 18. In some embodiments, sensor 116 is able to communication wirelessly (e.g., via radio frequency, Bluetooth, etc.) with remote devices such as, for example, a remote control configured to operate appliance 18.

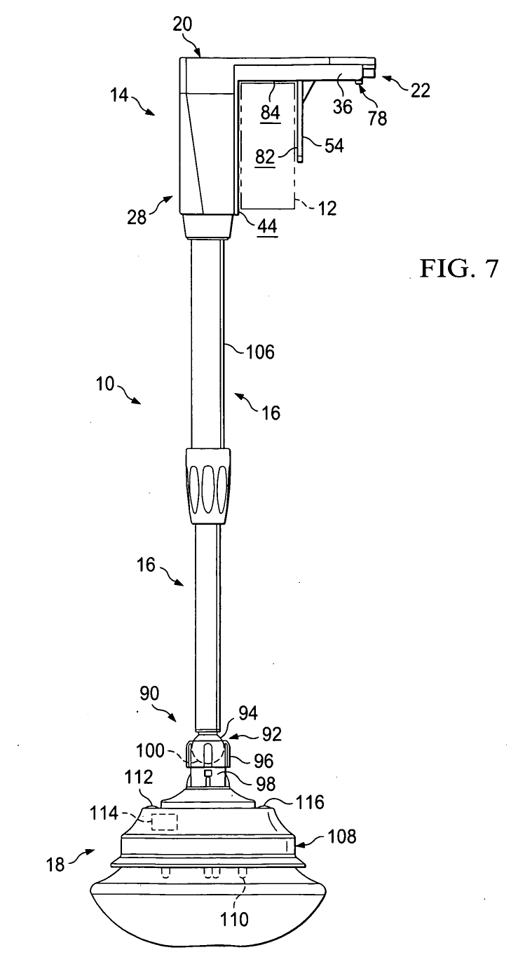

In operation, and with reference to FIGS. 6 and 7, adjustment member 22 is biased away from fixed base 20 by forcing resilient catch 58 to repeatedly deform and slide over adjacent protuberances 76. As the resistance of ratchet mechanism 80 is overcome in this fashion, rail structures 56 and rail structures 66 permit adjustment member 22 to slide horizontally away from fixed base 20. Movement of adjustment member 22 relative to fixed base 20 continues until width 88 of beam channel 86 is sufficiently greater than a width of support beam 12 in the support structure.

With beam channel 86 expanded to the appropriate width, fixture 10 is elevated such that mounting assembly 14, and in particular beam channel 86, is oriented above support beam 12. When beam channel 86 and support beam 12 are aligned, fixture 10 is lowered such that support beam 12 is received in beam channel 86. Fixture 10 generally continues to be lowered until the top surface of support beam 12 engages bottom surface 84 of adjustment member 22.

With support beam 12 disposed in beam channel 86, adjustment member 22 is biased toward fixed base 20 by forcing resilient catch 58 to slide over adjacent protuberances 76 of strip 74. Either or both of resilient catch 58 and protuberances 76 may deform during this process. As the resistance of ratchet mechanism 80 is overcome in this fashion, rail structures 66 slideably carries adjustment member 22 horizontally toward fixed base 20. Movement of adjustment member 22 relative to fixed base 20 continues until width 88 of beam channel 86 is approximately the same as the width of support beam 12 and/or until abutment surface 44 and abutment surface 82 engage with opposing surfaces of support beam 12. In this configuration which is depicted in FIG. 7, fixture 10 is in a clamped state. If desired, a connector may be inserted through mounting apertures 46 to secure extension flange 40 and depending flange 54 to support beam 12.

When suspended from support beam 12, solar panel 50 is generally directed toward the sun and charges rechargeable power source 48. When rechargeable power source 48 is sufficiently charged, switch 112 is moved from the off position to an on position and the LED's 110 of lamp 108 are illuminated to light the leisure area. To move lamp 108 either up or down, adjustment mechanism 102 is rotated in one direction, extension arm 16 is contracted or expanded, and adjustment mechanism 102 is rotated in the other direction. To orient the direction of the light emitted by lamp 108, lamp 108 is turned using ball joint 92 and socket 100.

If an appliance 18 other than lamp 108 is desired, threaded sleeve 96 is rotated relative to threaded shaft 98 in one direction until appliance 18 disengages from the extension arm 16. Thereafter, a threaded shaft 98 of a different appliance 18 (e.g., a ceiling fan) is aligned with sleeve 96 and rotated until ball 94 is held within socket 100. If not already on, switch 112 may be manipulated to operate the ceiling fan. In this manner, various appliances 18, all potentially having a different operation, may be interchanged.

When fixture 10 is no longer needed, the connectors (if any were used) are removed from mounting apertures 46, width 88 of beam channel 86 is expanded by biasing adjustment member 22 away from fixed base 20. When this occurs, resilient catch 58 slides over adjacent protuberances 76 of strip 74 and either or both of resilient catch 58 and protuberances 76 deform. When adjustment member 22 is pulled away from fixed base 20, depending flange 54 of abutment wall 26 is spaced apart from support beam 12 and fixture 10 is in the unclamped state of FIG. 6. Thereafter, fixture 10 is lifted up and away from support beam 12 so that fixture 10 may be stored, outfitted with a different appliance 18, repositioned on support beam 12 and once again clamped in place, and the like.

From the foregoing, those skilled in the art will recognize that fixture 10 is able to conveniently provide lighting or some other benefit to the leisure area.

What is claimed is:

1. A portable outdoor fixture adapted to be supported by a beam of a shelter structure, comprising:
a mounting assembly having an adjustment member operably coupled to a fixed base to permit clamping of the beam, the adjustment member releaseably locked in position relative to the fixed base through interaction of a ratchet mechanism interposed between the adjustment member and the fixed base;
an extension arm extending from the fixed base of the mounting assembly toward a coupling end; and
an appliance disposed at the coupling end of the extension arm.

2. The portable outdoor fixture of claim 1, wherein the ratchet mechanism is a resilient catch on the fixed base and a strip of protuberances on the adjustment member.

3. The portable outdoor fixture of claim 1, wherein the adjustment member and the fixed base are operably coupled to each other through cooperating rail structures, the rail structures permitting the adjustment member to telescopically slide into and out of the fixed base.

4. The portable outdoor fixture of claim 1, wherein the mounting assembly supports a solar panel and a rechargeable power source, the rechargeable power source in electrical communication with the solar panel and the appliance.

5. The portable outdoor fixture of claim 1, wherein the adjustment member and the fixed base form a beam channel configured to receive the beam.

6. The portable outdoor fixture of claim 5, wherein the beam channel is expanded or contracted by sliding the adjustment member relative to the base using mating rail structures.

7. The portable outdoor fixture of claim 1, wherein opposing abutment surfaces are configured to clamp the beam and a top surface of the adjustment member is configured to engage the beam.

8. The portable outdoor fixture of claim 1, wherein the extension arm includes an adjustment mechanism along a length thereof, the adjustment mechanism employed to increase or decrease the length of the extension arm to position the appliance further from or closer to the fixed base and to detach a section of the extension arm from another section of the extension arm.

9. The portable outdoor fixture of claim 1, wherein the coupling end is a universal coupling end including a ball joint and a socket.

10. The portable outdoor fixture of claim 1, further comprising a sensor for sensing a characteristic of an environment proximate the appliance, the sensor causing the appliance to experience a change in state when the characteristic or a lack of the characteristic is sensed.

11. The portable outdoor fixture of claim 1, wherein the appliance is an appliance selected from the group consisting of a light, a fan, a clock, a heater, and a combination light and fan.

12. The portable outdoor fixture of claim 1, wherein the appliance is operably coupled to the extension arm via universal coupling permitting the appliance to swivel relative to the extension arm.

13. A portable outdoor fixture configured to engage with a beam of a shelter structure, comprising:
a mounting assembly configured to clamp opposing sides of the beam, the mounting assembly supporting a solar cell electrically coupled to a rechargeable power source; and
an extension arm extending away from the mounting assembly toward a universal coupling end, the universal coupling end configured to receive a selected one of a plurality of differently operating types of appliances and to permit electrically coupling of the selected one to the rechargeable power source.

14. The portable outdoor fixture of claim 13, wherein a portion of the mounting assembly is configured to engage with a top surface of the beam and includes a horizontally slideable adjustment member.

15. The portable outdoor fixture of claim 13, wherein the mounting assembly includes a ratchet mechanism and mating rail structures.

16. A solar powered outdoor lighting fixture configured to engage with a beam of a shelter structure, comprising:
a mounting assembly having an adjustment member and a fixed base slideably coupled together by cooperating rail structures and collectively defining a beam channel, the adjustment member horizontally slideable toward or away from the fixed base in discrete increments to decrease or increase, respectively, a width of the beam channel;
a rechargeable power source supported by the mounting assembly;
a solar panel supported by the mounting assembly and electrically coupled with the rechargeable power source; and
an appliance spaced apart from the fixed base by an extension arm, the appliance powered by the rechargeable power source.

17. The solar powered outdoor lighting fixture of claim 16, wherein the appliance is a lamp formed from a plurality of light emitting diodes of at least one color.

18. The solar powered outdoor lighting fixture of claim 16, wherein the beam channel includes first, second and third surfaces, the first and third surfaces configured to clamp opposing sides of the beam and the second surface configured to rest upon a top surface of the beam.

19. The solar powered outdoor lighting fixture of claim 16, wherein the adjustment member is alternatively horizontally slideable to place the fixture in a clamped state, where two opposing sides of the beam channel engage with the beam, and to place the fixture in an unclamped state, where at least one of the two opposing sides of the beam channel is laterally spaced apart from the beam.

20. The solar powered outdoor lighting fixture of claim 16, further comprising a timer operably coupled to the appliance, the timer restricting operation of the appliance a predetermined amount of time.
